(19) United States
(12) Patent Application Publication
(10) Pub. No.: US 2017/0225450 A1
(43) Pub. Date: Aug. 10, 2017

(54) PROCESS FOR PRINTING WATER SOLUBLE FILM

(71) Applicant: The Procter & Gamble Company, Cincinnati, OH (US)

(72) Inventors: Andrea GABRIELE, Brussels (BE); Miguel BRANDT SANZ, Tervuren (BE); Nikola CURCIC, Mechelen (RS)

(21) Appl. No.: 15/040,556

(22) Filed: Feb. 10, 2016

(51) Int. Cl. B41F 23/00; B41F 17/38

(52) U.S. Cl. CPC B41F 23/002; B41F 17/38; B41F 7/00

(57) ABSTRACT

A process including the steps of: providing a water soluble film; providing an ink including between about 5% and about 30% by weight a solvent selected from the group consisting of diols, cyclic polyols, diglycols, triols, polyols, and mixtures thereof; and applying the ink onto the water soluble film.

### FIELD OF THE INVENTION

Process for printing water soluble film.

### BACKGROUND OF THE INVENTION

The evolution of printing on substrates is being driven by a desire to print at increasingly higher line speeds. To achieve this result, attention has been focused on designing inks that dry rapidly so that the ink on the printed substrate is not smeared when the substrate is handled downstream of the location at which ink is applied to the substrate.

Water soluble films are increasingly being used to form single unit dose pouches for surface treatment compositions. For instance, single unit dose pouches containing powder and or liquid detergents for washing dishware and laundry are widely available in the market. As the variety of these types of products has expanded, the need for providing usage instructions to consumers increased.

Providing printing on water soluble pouches faces a number of limitations. First, the pouches are often handled in a moist or wet environment such as a kitchen or laundry room. If the consumer's fingers are wet, the water from the consumer's fingers can partially dissolve the pouch. If the pouch is carrying printed instructions on the exterior of the pouch, the printing can become smudged and illegible. Further, as the pouches are filled into containers on a manufacturing line, the pouches may abrade with one another, thereby smudging or otherwise marring printing on the exterior of the pouch. Further, fixing ink to water soluble materials can be challenging and ink on the exterior of a pouch can transfer to a surface that the pouch comes into contact with. Such surfaces might include a butcher block kitchen counter, an article of light colored clothing resting on the top of an automatic dryer that is next the washing machine, the interior of the container containing the pouches, the consumer's fingers, and or manufacturing equipment used to manufacture the pouches. Providing printing on the interior of the pouch may help to overcome some of the aforesaid problems but chemical compatibility of the ink and the surface treatment composition can be a concern. Thus, maintaining quality of a printed image on a surface of a water soluble film is a significant challenge.

If the printing and pouch forming operations are carried out in-line on a single manufacturing line, providing printing on pouches can become more challenging. Typically, water soluble pouches are formed at a line speed much slower than typical paper printing line speeds. This is so because the usual approach for forming water soluble pouches is to vacuum thermoform the water soluble film to form a chamber into which the surface treatment composition can be place and then the chamber is closed by sealing edges of the chamber to another web of water soluble film. The vacuum thermoforming, filling, and sealing operations can be rate limiting processes. If vertical form filling operations are used, the same aspects can be rate limiting. Printing a slowly moving web via a printing method in which an ink is transferred from a surface to the web can be challenging because the ink may dry too much while on the surface from which ink is transferred to the water soluble film.

In the field of printing on water soluble films there is a continuing unaddressed need for printing processes that can be used on water soluble films that enable maintaining quality and integrity of a printed image that is exposed to moisture and abrasion. There is a further continuing unaddressed need for printing processes that can be used on slowly moving webs of water soluble film.

### SUMMARY OF THE INVENTION

A process comprising the steps of: providing a water soluble film; providing an ink comprising between about 5% and about 30% by weight a solvent selected from the group consisting of diols, cyclic polyols, diglycols, triols, polyols, and mixtures thereof; and applying the ink onto the water soluble film and incorporating a surface treatment composition onto, into, at least partially enclosed by, or enclosed by the water soluble film; wherein the surface treatment composition is selected from the group consisting of a fabric conditioner, a laundry conditioner, a fabric detergent, a laundry detergent, a laundry rinse additive, a hard surface cleaner, a hard surface treatment composition, an air care composition, a car care composition, a dishwashing composition, a composting composition, a cleaning product, and combinations thereof.

A process comprising the steps of: providing a water soluble film comprising polyvinyl alcohol; providing an ink comprising between about 10% and about 25% by weight propylene glycol; and applying the ink onto the water soluble film; and incorporating a surface treatment composition onto, into, at least partially enclosed by, or enclosed by the water soluble film; wherein the surface treatment composition is selected from the group consisting of a fabric conditioner, a laundry conditioner, a fabric detergent, a laundry detergent, a laundry rinse additive, a hard surface cleaner, a hard surface treatment composition, an air care composition, a car care composition, a dishwashing composition, a composting composition, a cleaning product, and combinations thereof; wherein the ink is applied onto the water soluble film by an ink application process selected from the group consisting of flexographic printing, gravure printing, lithographic printing, and pad printing; and wherein the water soluble film is provided as a continuous web moving at a speed between about 2 m/min and about 50 m/min.

### BRIEF DESCRIPTION OF THE DRAWINGS

FIG. 1 is an apparatus for printing water soluble film.

FIG. 2 is a gravure printing apparatus.

FIG. 3 is a flexographic printing apparatus.

FIG. 4 is a lithographic printing apparatus.

FIG. 5 is a pad printing apparatus.

FIG. 6 is a process for printing a water soluble film and forming a pouch there from.

FIG. 7 is a process for printing a water soluble film and forming a pouch there from.

FIG. 8 is process for printing a water soluble film.

FIG. 9 is a process for printing a water soluble film and forming a pouch there from.

FIG. 10 is a mold for forming a pouch.

FIG. 11 is a pouch.

### DETAILED DESCRIPTION OF THE INVENTION

The process for printing on a water soluble film can comprise the steps of: providing a water soluble film; providing an ink comprising between about 5% and about 30% by weight a solvent selected from the group consisting of diols, cyclic polyols, diglycols, triols, polyols, and mixtures thereof; and applying said ink onto said water soluble film.

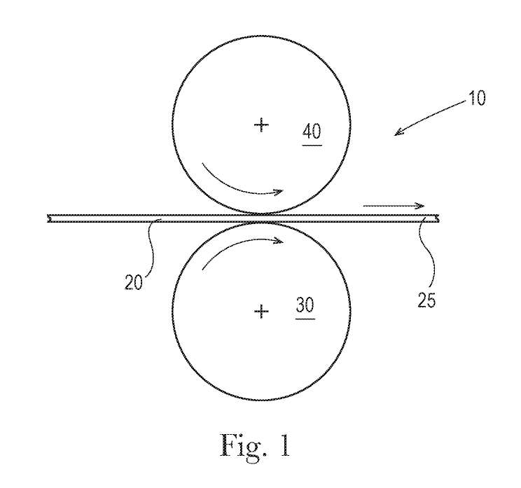

A typical apparatus 10 for printing a water soluble film 20 is shown in FIG. 1. The apparatus 10 can comprise a print cylinder 30 and an impression roller 40 the water soluble film is conveyed between the print cylinder 30 and impression roller 40. An image is applied on the water soluble film by the print cylinder 30. The apparatus 10 shown in FIG. 1 is similar for gravure printing and flexographic printing, the difference amongst these printing processes being the role of the print cylinder 30.

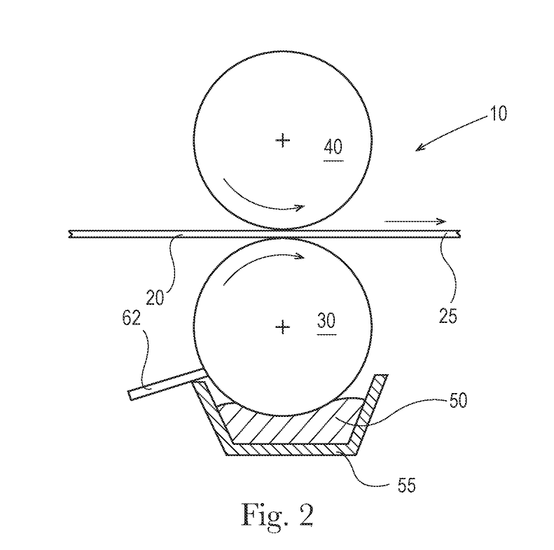

An apparatus 10 for gravure printing is shown in FIG. 2. In gravure printing, the print cylinder 30 is etched with sunken cells that contain the ink that will be applied to the water soluble film 20. Ink can be supplied to the print cylinder by immersing a portion of the print cylinder 30 in an ink 50 provided in an ink bath 55 or supplying ink 50 to the print cylinder 30 in some other manner. A doctor blade 62 can be provided to wipe excess ink 50 off the print cylinder 30 leaving ink 50 within the cells in the print cylinder 30. The ink 50 in the cells of print cylinder 30 is transferred from the print cylinder 3 to the water soluble film 20. Typically, the print cylinder 30 for gravure printing is etched metal, which tends to make gravure print cylinders 30 relatively expensive compared to components used in other printing processes.

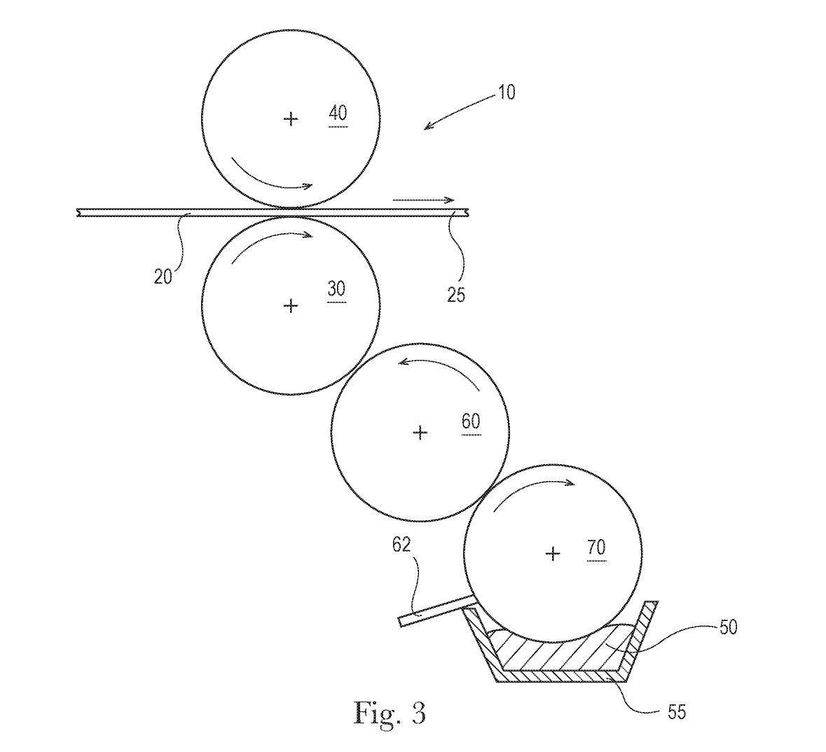

An apparatus for flexographic printing is shown in FIG. 3. In flexographic printing, the print cylinder 30 has raised portions on which the ink 50 is carried and applied to the water soluble film 20. Ink 50 is supplied to the print cylinder by an anilox roller 60. A portion of the anilox roller 60 can be immersed in an ink 50 provided in an ink bath 55. Optionally a portion of a fountain roll 70 can be immersed in an ink 50 provided in an ink bath 55 and ink 50 can be transferred from the fountain roll 70 to the anilox roll 60 to provide for better control over the amount of ink 50 on the anilox roll 60. Typically, the print cylinder 30 for flexographic printing is made from a polymeric material and the raised portions carry the ink 50 that is applied to the water soluble film 20.

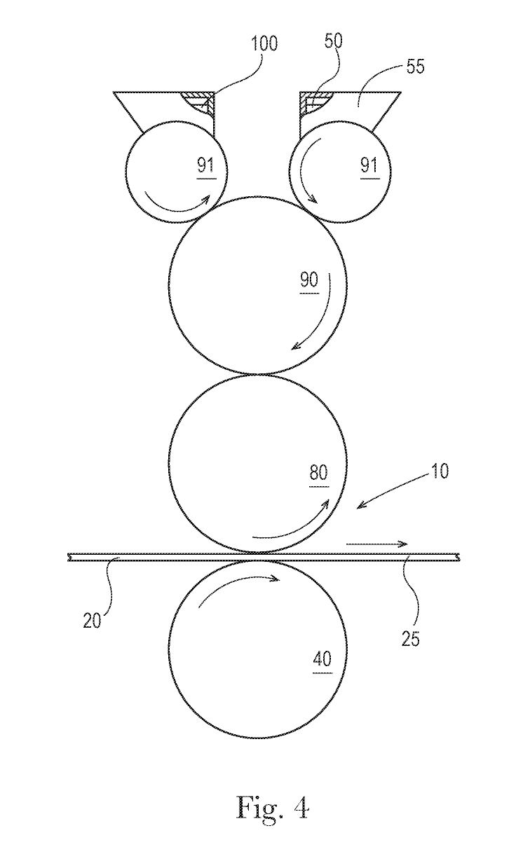

An apparatus 10 for lithographic printing is shown in FIG. 4. In lithographic printing, ink 50 is applied to the water soluble substrate 20 by a blanket cylinder 80. The blanket cylinder 80 carries the image that is applied to the water soluble substrate 20. The plate cylinder 90 has oleophilic portions and hydrophilic portions. A hydrophilic fountain solution 100 is applied to the plate cylinder 90 with applicator 91 and the hydrophilic fountain solution 100 occupies the hydrophilic portions of the plate cylinder 90. Ink 50 is then applied to the wetted plated cylinder 90 with applicator 91 and occupies the oleophilic portions of the plate cylinder 90. The image comprised of ink 50 is transferred from the plate cylinder 90 to the blanket cylinder 80. The blanket cylinder 80 applies the image comprising the ink 50 to the water soluble film 20.

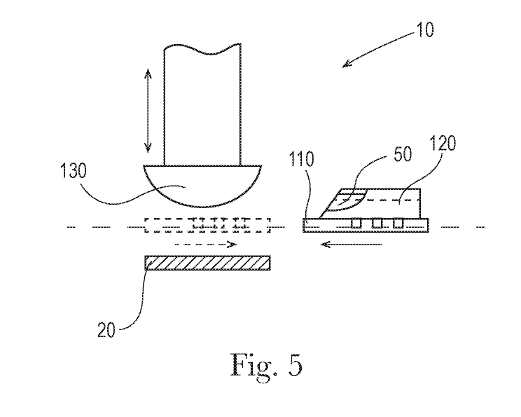

An apparatus 10 for pad printing is shown in FIG. 5. The cliché 110 has the image that is ultimately imprinted upon the water soluble film or finished water soluble pouch. In operation, the cliché 110 reciprocates between a position beneath the ink container 120 and a position beneath the pad 130. After the portion of the cliché 110 that contains the ink 50 moves out to be beneath the pad 130, the pad 130 contacts the cliché 110 to pick up the ink 50. The pad 130 then moves away from the cliché 110 and the portion of the cliché 110 that formerly contained the ink 50 moves back to be beneath the ink container 120 to be reloaded with ink 50. The pad 130 carrying the ink 50 and the water soluble film 20 are then contacted to one another to apply the ink 50 from the pad 130 to the water soluble film 20. The pad 130 and the water soluble film 20 are then separated from one another. Pad printing can be practical for printing flat water soluble film 20 or three-dimensionally shaped finished products formed from water soluble film 20. For example, pad printing can be used on finished water soluble pouches.

Gravure printing, flexographic printing, lithographic printing, and pad printing are similar to one another in that the ink 50 in final form such as an image or coating is temporarily held on a surface before being applied to the water soluble film 20. In the aforementioned printing process, the ink 50 in final form such as an image or coating is held on a print cylinder 30 in gravure printing and flexographic printing, on a blanket cylinder 80 in lithographic printing, and on a pad 130 in pad printing. There are multiple other such printing processes in which the image comprising ink 50 in final form is temporarily held on a surface before being applied on a water soluble film 20 and the surface contacts the object to which ink 50 is to be applied. The ink 50 can be applied as a coating or printed as an image, character, indicia, or portion thereof.

As described herein, the process for printing a water soluble film 20 can include a step in which the ink 50 in its final form is temporarily held on a surface before being applied to the water soluble film 20.

The ink 50 needs to remain sufficiently wet while it resides on a surface before being applied on a water soluble film 20. Intuitively this would tend to drive one skilled in the art to employ the fastest printing speeds possible so as to minimize the amount of time the ink 50 in its final form is temporarily held on a surface of the apparatus that applies the ink. Increased printing speed creates another problem in that the ink 50 needs to dry quickly on the printed material so that the material can be handled downstream of the printing station without smudging or smearing the ink 50 applied to the printed material. If the ink 50 dries quickly on the water soluble film 20, the ink 50 will tend to reside on the surface of the water soluble film 20. Ink 50 that resides on the surface of the water soluble film 20 may be easily smeared, smudged, or abraded due to the soft surface of the water soluble film 20 and the storage and use environments of finished products such as water soluble pouches.

To improve on the ability of the water soluble film 20 and finished products formed from such film to resist marring of the ink 50 applied thereto, it can be desirable to design the ink 50 such that it can penetrate into the water soluble film 20. By having an appreciable amount of the ink 50 in the water soluble film 20 as opposed to on the water soluble film 20, when the water soluble film 20 is subjected to stress during printing, manufacture of finished product, storage of finished product, and use of finished product, the ink 50 is protected from being marred. Water-based ink 50 tends to be soluble into the water soluble film 20, thereby providing a mechanism for getting the ink 50 into the water soluble film 50. The ability for water based ink 50 to get into the water soluble film 20 can be enhanced by providing for more time for the water based ink 50 to solubilize into the water soluble film 20. More time can be provided by using a slow printing speed. If the printing speed is slowed down to a degree such that ink 50 has time to migrate into the water soluble film 20 the speed can be so slow that the ink 50 becomes too dry when it resides on a surface of the printing apparatus before being transferred to the water soluble film 20.

So, what is needed is a process for printing a water soluble film 20 in which the ink 50 is slow drying on components of the printing apparatus 10 yet fast absorbing into the water soluble film 20. Moreover, the process should be robust enough such that the same ink 50 can be successfully used in the variety of humidity and airflow conditions that might occur seasonally within a single printing facility and standardized across multiple printing facilities in various geographies that have different humidity and airflow conditions.

### Process

The process for applying ink 50 to a water soluble film 20 can comprise the steps of: providing a water soluble film; providing an ink comprising between about 5% and about 30% by weight a solvent selected from the group consisting of diols, cyclic polyols, diglycols, triols, polyols, and mixtures thereof; applying said ink onto said water soluble film; and incorporating a surface treatment composition onto, into, at least partially enclosed by, or enclosed by said water soluble film. The surface treatment composition can be selected from the group consisting of a fabric conditioner, a laundry conditioner, a fabric detergent, a laundry detergent, a laundry rinse additive, a hard surface cleaner, a hard surface treatment composition, an air care composition, a car care composition, a dishwashing composition, a composting composition, a cleaning product, and combinations thereof. The water soluble film 20 can be provided as a continuous web of water soluble film 20. Optionally the water soluble film 20 can be provided as part of an already finished product formed from water soluble film 20. The ink 50 can be applied onto the water soluble film 20 by an ink application process selected from the group consisting of flexographic printing, gravure, printing, lithographic printing, and pad printing. The process can further comprise the step of forming a pouch comprising the water soluble film 20 after applying the ink 50 to the water soluble film 20.

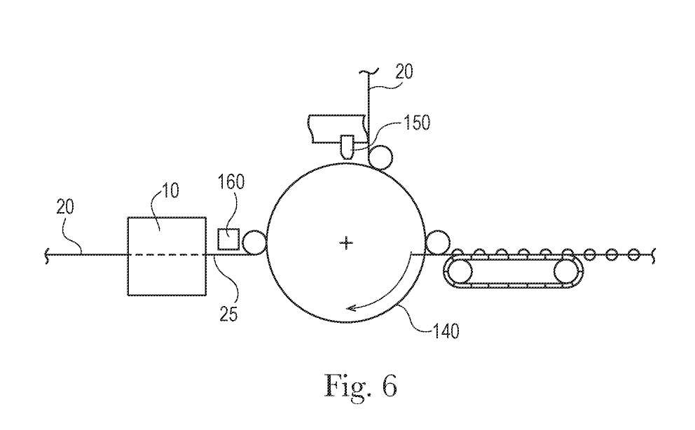

The process can be as shown in FIG. 6 in which a web of water soluble film 20 is provided to the apparatus 10 for applying ink 50 to the water soluble film 20. The water soluble film can be optionally preheated prior to printing to provide for improved print quality. After the ink 50 is applied to the water soluble film 20, the film can travel on a forming surface 140. The forming surface 140 can be a rotating drum or a flat movable surface. The forming surface 140 can comprise a plurality of pockets into which the water soluble film 20 can be drawn or thermoformed. A dispenser 150 can be located above the forming surface 140 so that the water soluble film 20 passes beneath the dispenser 150. The water soluble film 20 can be formed into a shape that can contain a surface treatment composition that is dispensed from the dispenser 150. Another water soluble film 20 can be contacted with the water soluble film 20 that is on the forming surface 140 to form a pouch containing the surface treatment composition. The pouch can be conveyed further downstream in the process. If a plurality of pouches are formed from a continuous web of water soluble film 20, the web of finished pouches can be conveyed further downstream and cut into individual pouches. A dryer 160 can be provided downstream of the apparatus 10 that applies the ink 50 to the water soluble film 20.

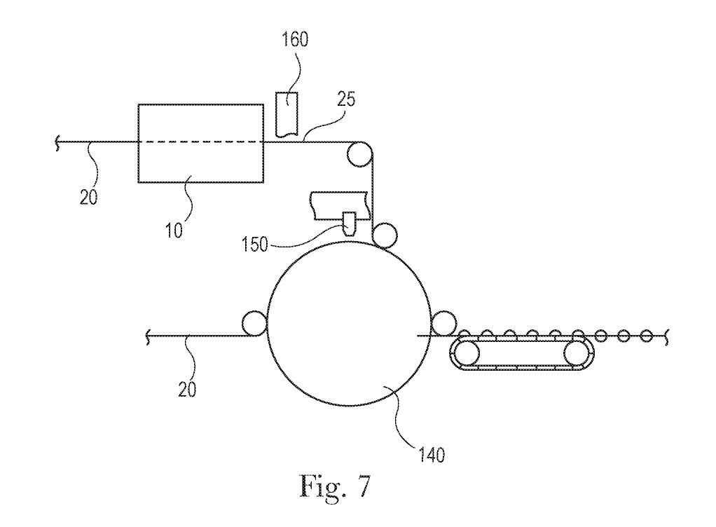

Optionally, the process can be as shown in FIG. 7 in which a web of water soluble film 20 is provided to the apparatus 10 for applying ink 50 to the water soluble film 20. After the ink 50 is applied to the water soluble film 20, the water soluble film 20 having ink 50 thereon can be contacted to another water soluble film 20 that is on a forming surface 140 to form a chamber for a surface treatment composition. The forming surface 140 can comprise a plurality of pockets into which the water soluble film 20 can be drawn or thermoformed. The difference between the options shown in FIGS. 6 and 7 is that in the former, the water soluble film 20 to which ink 50 is applied is formed into a shape to contain a surface treatment composition and another water soluble film 20 is brought into contact with the shaped water soluble film 20 containing the surface treatment composition to form a chamber. In the latter, the water soluble film 20 to which ink 50 is applied is brought into contact with a water soluble film 20 that is shaped to contain a surface treatment composition to form a chamber. A dryer 160 can be provided downstream of the apparatus 10 that applies the ink 50 to the water soluble film 20.

A dryer 160 can be provided downstream of the apparatus 10 that applies the ink 50 to the water soluble film 20. After the ink 50 is applied to the water soluble film 20 to form a printed water soluble film 25, the printed water soluble film 25 can be actively dried. Active drying can be beneficial for helping the ink 50 to set in and on the water soluble film 20 so that the ink 50 printed in and on the water soluble film 25 is less susceptible to marring or degradation. Actively drying, in contrast to passive drying, is performed by purposefully locally applying drying energy to the printed water soluble film 25. Local energy can be applied by exposing the printed water soluble film 25 to heat, air, dry air, and the like.

The ink 50 can be applied to the water soluble film in an environment having a relative humidity between about 0% and about 100%. The ink 50 can be applied to the water soluble film in an environment having a relative humidity between about 0% and about 60%. Such environment may be dry enough such that the ink 50 can dry sufficiently fast enough so that the freshly applied ink 50 can be sufficiently dry so that water soluble film 20 can be handled by automated equipment without marring of the ink 50 printed thereon. At a relative humidity greater than about 60%, the ink 50 may dry too slowly and water soluble film 20 having freshly applied ink 50 thereon may be difficult to handle without marring of the ink 50 printed thereon.

In the processes as shown in FIGS. 6 and 7, it is possible to invert the water soluble film 20 that has ink 50 applied thereto so that the ink 50 ends up on an inside surface of the pouch. Providing the ink 50 on an inside surface of the pouch can be beneficial in that the ink 50 is not exposed to being contacted when the finished pouches are handled, stored, or used. This can reduce the incidence of marring of the ink 50. A drawback to positioning the ink 50 on an inside surface of the pouch is that the ink 50 can be exposed to the surface treatment composition contained in pouch. But, as described herein, at least a portion of the ink 50 that is provided solubilizes into the water soluble film 20, thereby protecting such ink 50 from being degraded by the constituents of the surface treatment composition contained in the pouch.

When flexographic printing or gravure printing is employed in the process of applying the ink 50, it can be practical that the ink 50 is retained on the print cylinder 30, flexographic print cylinder 30 or gravure print cylinder 30 as applicable, for between about 0.5 seconds and about 8 seconds before being printed on the water soluble film. The time period can be suitable because it is short enough such that the ink 50 remains wet enough to be transferred from the flexographic print cylinder 30 to the water soluble film 20. Further, the ink 50 remains wet enough so as to be solubilized into the film 20 after being applied to the water soluble film 20.

In the process for applying ink 50 onto water soluble film 20, the water soluble film 20 can be provided as a continuous web moving at a speed between about 2 m/min to about 50 m/min. Such web speed can be suitable when a flexographic print cylinder 30 or gravure print cylinder 30 is employed. Such a range of speeds can be practical because at or below the higher end of the range for speed, the ink 50 applied to the water soluble film 20 may have sufficient time to dry and or solubilize into the water soluble film 20 before the water soluble film 20 contacts another appurtenance, such as a roller, downstream of the print cylinder 30. Below the lower range of speeds, the ink 50 may completely dry on the print cylinder 30, which may impair quality printing.

As described herein, the ink 50 can be applied to the water soluble film 20. The ink 50 can be applied as a coating that coats the entire surface of the water soluble film 20 that makes up a pouch. Such a coating 50 might be practical for providing a film that has a desired color. A coating 50 can also be provided to be the background over which additional ink 50 is printed. For instance, more than one printing apparatus 10 to apply different colors of ink 50 to the water soluble film 20 can be provided. The ink 50 can be applied as printing in which characters, symbols, and other discrete patterns of ink 50 are applied to the water soluble substrate 20.

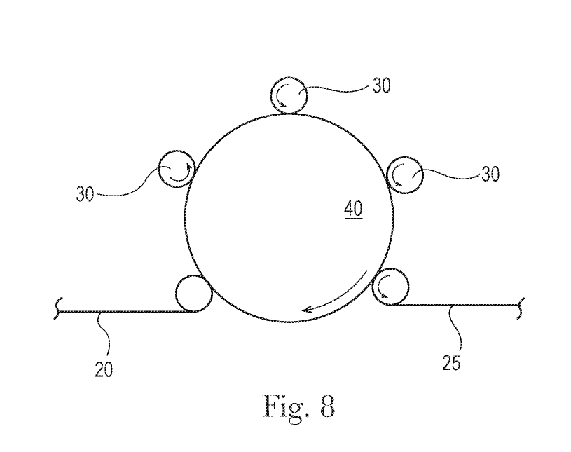

Multiple colors of ink 50 can be applied to water soluble film 20. This can be done by providing a plurality of printing apparatuses 10 in series with one another. A more integrated system can be provided by employing a single impression roller 40 and a plurality of print cylinders 30, or blanket cylinders 80 if lithographic printing is employed, that print different colors about the impression roller 40. The pint cylinder 30 on the left of the impression roller 40 in FIG. 8 can apply a first color. The first color might provide a background for other colors that are subsequently applied to the water soluble film 20. The print cylinder 30 on the top of FIG. 8 can apply a second color. The second color can be black ink 50. The second color can be applied to form characters, symbols, and other discrete patterns of ink 50. The print cylinder 30 on the right of FIG. 8 can apply a third color. The third color can be red ink 50. The third color can be applied to form characters, symbols, and other discrete patterns of ink 50.

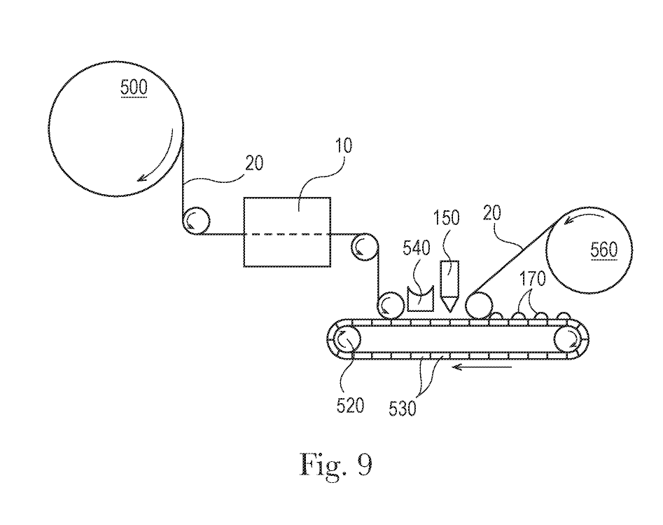

A pouch forming apparatus for forming a pouch 170 is shown in FIG. 9. The pouch forming apparatus can comprise a first web feed roll 500 that feeds water soluble film 20, a printing apparatus 10, a conveyor system 520, a plurality of molds 530 movably mounted on the conveyor system 520, an optional heater 540, a dispenser 150, and a second web feed roll 560 that feeds water soluble film. The water soluble film 20 can be fed through the printing apparatus 10. The printing apparatus 10 can print the ink 50 onto the water soluble film 20. The printed water soluble film 20 can then be fed onto the conveyor system 520.

The printing apparatus 10 can be located between the first web feed roll 500 and the conveyor system 520. Optionally the printing unit 510 can be located between the second web feed roll 560 and the conveyor system 520. Optionally a plurality of printing units 510 can be located between the first web feed roll 500 and the conveyor system 520. Optionally a plurality of printing units 510 can be located between the second web feed roll 560 and the conveyor system 520. One or more printing apparatuses 10 can be located between both of first web feed roll 500 and the conveyor system 520 and the second web feed roll 560 and the conveyor system 520. Optionally, the first web feed roll 500 and or second web feed roll 560 can be a pre-printed web feed roll and the printing apparatus 10 can be eliminated.

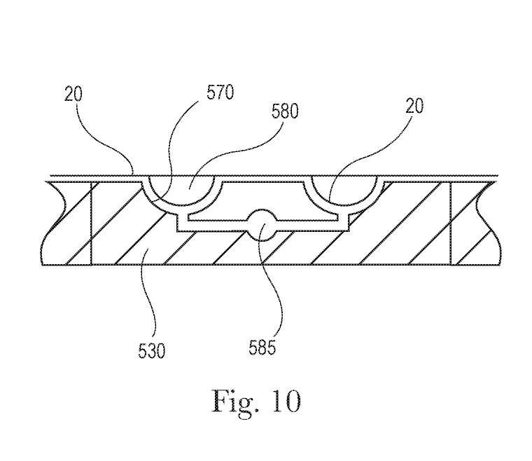

Once on the conveyor system 520, the water soluble film 20 can be plastically deformed in cups 570 in the mold 530, as shown in FIG. 10. The plastic deformation can be provided by thermoforming, thermoforming being considered to be a subset of plastic deformation. The water soluble film 20 can be heated and drawn in to cups 570 in the mold 530, as shown in FIG. 10. The water soluble film 20, heated or unheated above ambient temperature, can be drawn in by a vacuum applied to the face of the cups 570 via a vacuum transmission system 585. The compartment 580 formed by water soluble film can then be filled or partially filled with the surface treatment composition by the dispenser 150. A second water soluble film 20 is then brought into facing relationship with the plastically deformed water soluble film 20 and sealed to the plastically deformed water soluble film 20 to form a pouch 170. With the addition of heat, the plastic deformation described herein can be thermoforming. The water soluble film 20 can be preheated prior to being plastically deformed.

Any suitable process of sealing the water soluble films 20 may be used. The sealing may occur in the landing areas between individual cups 570 of the molds 530. Non-limiting examples of such means include heat sealing, solvent welding, solvent or wet sealing, and combinations thereof. Heat and or solvent can be applied to the entire surface of the water soluble film or only the area which is to form the seal is treated with heat or solvent. The heat or solvent can be applied by any process, typically on the closing material, and typically only on the areas which are to form the seal. If solvent or wet sealing or welding is used, heat can also be applied. Wet or solvent sealing/welding processes include selectively applying solvent onto the area between the molds, or on the closing material, by for example, spraying or printing this onto these areas, and then applying pressure onto these areas, to form the seal. Sealing rolls and belts as described above that optionally also provide heat can be used, for example. The water soluble films 20 can be sealed in unprinted regions. Heat and or solvent can be applied to the entire surface of the water soluble film, unprinted regions of the water soluble film, or only the area which is to form the seal is treated with heat or solvent

A cutting operation can be integral with or located down-stream of the apparatus shown in FIG. 9 to separate the pouches 170 into individual pouches 170. The formed pouches 170 may then be cut by a cutting device. Cutting can be accomplished using any known process. The cutting can be done in continuous manner, optionally with constant speed and in a horizontal position. The cutting device can, for example, be a sharp item or a hot item, whereby in the latter case, the hot item ‘burns’ through the sheet/sealing area.

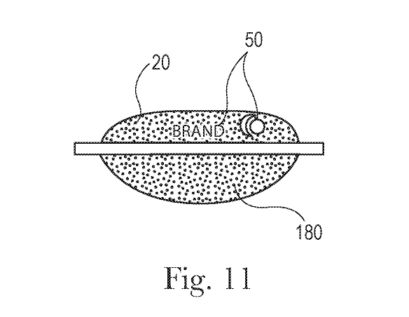

A finished pouch 170 is shown in FIG. 11. As shown in FIG. 11, the pouch 170 can comprise water soluble film 20 containing a surface treatment composition 180. Pad printing can be used to apply ink to finished pouches 170. Pad printing is suited for printing objects having irregular surfaces since a pliable pad 130 can be employed in the process.

### Surface Treatment Composition

The surface treatment composition 180 can be selected from the group consisting of a fabric conditioner, a laundry conditioner, a fabric detergent, a laundry detergent, a laundry rinse additive, a hard surface cleaner, a hard surface treatment composition, an air care composition, a car care composition, a dishwashing composition, a composting composition, a cleaning product, and combinations thereof. A fabric conditioner and laundry conditioner can be a softener that imparts a better feel to fabrics or laundry articles, a wrinkle removal or prevention composition, a disinfectant, a malodor reduction or treatment composition, a stain prevention composition, or fabric or laundry article surface modification composition. A fabric detergent or laundry detergent can be composition designed for cleaning fabrics or laundry articles. A laundry rinse additive can be composition designed to be added during the rinse cycle to impart a benefit during the rinse cycle. A hard surface cleaner can a composition designed for cleaning hard surfaces including, but not limited to, flooring, countertops, toilets, showers, bathtubs, tile, glass, acrylic, windows, hard household surfaces, and the like. A hard surface treatment composition can be a composition designed to treat a hard surface such as by the application of a surface modification composition, wax, color restorer, feel restorer, mold resistant composition, mildew resistant composition, antifungal composition, stain protector, water resistant composition, and the like. An air care composition can be malodor reduction composition, perfume, or other composition dispersed into the air. A car composition can be, by way of non-limiting example, wax, a shine enhancement composition, or a composition for resisting adhesion of impacted insects, road grime, and pollution. A dishwashing composition can be a composition for cleaning and improvement of visual attributes of dishware. A composting composition can be a composition that can increase the rate, quality, or volume of composted material. A cleaning product can be, by way of non-limiting example a composition for removing undesirable materials from a surface.

### Water Soluble Film

The water soluble film 20 can be a polymeric material that can be formed into a sheet or film. The water soluble film 20 can, for example, be obtained by casting, blow-molding, extrusion or blown extrusion of the polymeric material, as known in the art. The water soluble film 20 can be a thermoplastic water soluble film 20.

The water soluble film 20 can have a thickness of from about 20 to about 150 micron, or even about 35 to about 125 micron, or even about 50 to about 110 micron, or even about 76 micron. The water soluble film 20 can have a thickness of from about 75 microns to about 90 microns.

The water soluble film can have a water-solubility of at least 50%, or even at least 75%, or even at least 95%, as measured by the method set out hereafter using a glass-filter with a maximum pore size of 20 microns: 50 grams±0.1 gram of water soluble film is added in a pre-weighed 400 ml beaker and 245 ml±1 ml of distilled water is added. The temperature of the water soluble film, beaker, and distilled water is equilibrated to 24° C. prior to testing. This is stirred vigorously on a magnetic stirrer, labline model No. 1250 or equivalent and 5 cm magnetic stirrer, set at 600 rpm, for 30 minutes at 24° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Suitable polymers, copolymers or derivatives thereof suitable for use as water soluble film 20 for forming pouches can be selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. Suitable polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and suitably selected from polyvinyl alcohols, polyvinyl alcohol copolymers and hydroxypropyl methyl cellulose (HPMC), and combinations thereof. The level of polymer in the water soluble film, for example a PVA polymer, can be at least 60%. The polymer can have any weight average molecular weight, such as from about 1000 to about 1,000,000, or even from about 10,000 to about 300,000, or even from about 20,000 to about 150,000.

Mixtures of polymers can also be used as the water soluble film 20. This can be beneficial to control the mechanical and/or dissolution properties of the water soluble film 20, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000 to about 40,000, or even about 20,000, and of PVA or copolymer thereof, with a weight average molecular weight of about 100,000 to about 300,000, or even about 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1 to about 35% by weight polylactide and about 65% to about 99% by weight polyvinyl alcohol. Suitable for use herein are polymers which are from about 60% to about 98% hydrolysed, or even about 80% to about 90% hydrolysed, to improve the dissolution characteristics of the water soluble film 20.

Water soluble film 20 can exhibit good dissolution in cold water, meaning unheated distilled water. Such water soluble film 20 can exhibit good dissolution at a temperature of about 24° C., or even about 10° C. By good dissolution it is meant that the water soluble film 20 exhibits water-solubility of at least about 50%, or even at least about 75%, or even at least about 95%, as measured by the method set out herein and described above.

Suitable water soluble films 20 can be those supplied by Monosol under the trade references M8630, M8900, M8779, M8310, films described in U.S. Pat. No. 6,166,117 and U.S. Pat. No. 6,787,512 and PVA films of corresponding solubility and deformability characteristics. Further suitable water soluble films 20 can be those described in US2006/0213801, WO 2010/119022 and U.S. Pat. No. 6,787,512.

Water soluble film 20 can be a resin comprising one or more PVA polymers. The water soluble film 20 can comprise a blend of PVA polymers. For example, the PVA resin can include at least two PVA polymers, wherein as used herein the first PVA polymer has a viscosity less than the second PVA polymer. A first PVA polymer can have a viscosity of at least 8 centipoise (cP), 10 cP, 12 cP, or 13 cP and at most 40 cP, 20 cP, 15 cP, or 13 cP, for example in a range of about 8 cP to about 40 cP, or 10 cP to about 20 cP, or about 10 cP to about 15 cP, or about 12 cP to about 14 cP, or 13 cP. Furthermore, a second PVA polymer can have a viscosity of at least about 10 cP, 20 cP, or 22 cP and at most about 40 cP, 30 cP, 25 cP, or 24 cP, for example in a range of about 10 cP to about 40 cP, or 20 to about 30 cP, or about 20 to about 25 cP, or about 22 to about 24, or about 23 cP. The viscosity of a PVA polymer is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20° C. All viscosities specified herein in cP should be understood to refer to the viscosity of 4% aqueous polyvinyl alcohol solution at 20° C., unless specified otherwise. Similarly, when a resin is described as having (or not having) a particular viscosity, unless specified otherwise, it is intended that the specified viscosity is the average viscosity for the resin, which inherently has a corresponding molecular weight distribution.

The individual PVA polymers can have any suitable degree of hydrolysis, as long as the degree of hydrolysis of the PVA resin is within the ranges described herein. Optionally, the PVA resin can, in addition or in the alternative, include a first PVA polymer that has a Mw in a range of about 50,000 to about 300,000 Daltons, or about 60,000 to about 150,000 Daltons; and a second PVA polymer that has a Mw in a range of about 60,000 to about 300,000 Daltons, or about 80,000 to about 250,000 Daltons.

The PVA resin can still further include one or more additional PVA polymers that have a viscosity in a range of about 10 to about 40 cP and a degree of hydrolysis in a range of about 84% to about 92%.

When the PVA resin includes a first PVA polymer having an average viscosity less than about 11 cP and a polydispersity index in a range of about 1.8 to about 2.3, then in one type of embodiment the PVA resin contains less than about 30 wt % of the first PVA polymer. Similarly, when the PVA resin includes a first PVA polymer having an average viscosity less than about 11 cP and a polydispersity index in a range of about 1.8 to about 2.3, then in another, non-exclusive type of embodiment the PVA resin contains less than about 30 wt % of a PVA polymer having a Mw less than about 70,000 Daltons.

Of the total PVA resin content in the film described herein, the PVA resin can comprise about 30 to about 85 wt. % of the first PVA polymer, or about 45 to about 55 wt. % of the first PVA polymer. For example, the PVA resin can contain about 50 wt. % of each PVA polymer, wherein the viscosity of the first PVA polymer is about 13 cP and the viscosity of the second PVA polymer is about 23 cP.

One type of embodiment is characterized by the PVA resin including about 40 to about 85 wt % of a first PVA polymer that has a viscosity in a range of about 10 to about 15 cP and a degree of hydrolysis in a range of about 84% to about 92%. Another type of embodiment is characterized by the PVA resin including about 45 to about 55 wt % of the first PVA polymer that has a viscosity in a range of about 10 to about 15 cP and a degree of hydrolysis in a range of about 84% to about 92%. The PVA resin can include about 15 to about 60 wt % of the second PVA polymer that has a viscosity in a range of about 20 to about 25 cP and a degree of hydrolysis in a range of about 84% to about 92%. One contemplated class of embodiments is characterized by the PVA resin including about 45 to about 55 wt % of the second PVA polymer.

When the PVA resin includes a plurality of PVA polymers the PDI value of the PVA resin is greater than the PDI value of any individual, included PVA polymer. Optionally, the PDI value of the PVA resin is greater than 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.5, or 5.0.

The PVA resin can have a weighted, average degree of hydrolysis (H̅°̅) between about 80 and about 92%, or between about 83 and about 90%, or about 85 and 89%. For example, H° for a PVA resin that comprises two or more PVA polymers is calculated by the formula H̅°̅=Σ(Wi·H₁) where Wᵢ is the weight percentage of the respective PVA polymer and a Hᵢ is the respective degrees of hydrolysis. Still further it can be desirable to choose a PVA resin that has a weighted log viscosity (μ̅) between about 10 and about 25, or between about 12 and 22, or between about 13.5 and about 20. The μ̅ for a PVA resin that comprises two or more PVA polymers is calculated by the formula μ̅=e^{Σw}^{ᵢ}^{·ln μ}^{ᵢ} where μₗ is the viscosity for the respective PVA polymers.

Yet further, it can be desirable to choose a PVA resin that has a Resin Selection Index (RSI) in a range of about 0.255 to about 0.315, or about 0.260 to about 0.310, or about 0.265 to about 0.305, or about 0.270 to about 0.300, or about 0.275 to about 0.295, or about 0.270 to about 0.300. The RSI is calculated by the formula; Σ(Wᵢ|μₜ−μᵢ|)/Σ(Wᵢμᵢ), wherein μₜ is seventeen, μᵢ is the average viscosity each of the respective PVOH polymers, and Wᵢ is the weight percentage of the respective PVOH polymers.

Also suitable are water soluble films comprising a least one negatively modified monomer with the following formula:

[Y]-[G]ₙ

wherein Y represents a vinyl alcohol monomer and G represents a monomer comprising an anionic group and the index n is an integer of from 1 to 3. G can be any suitable comonomer capable of carrying of carrying the anionic group, optionally G is a carboxylic acid. G can be selected from the group consisting of maleic acid, itaconic acid, coAMPS, acrylic acid, vinyl acetic acid, vinyl sulfonic acid, allyl sulfonic acid, ethylene sulfonic acid, 2 acrylamido 1 methyl propane sulfonic acid, 2 acrylamido 2 methyl propane sulfonic acid, 2 methyl acrylamido 2 methyl propane sulfonic acid and mixtures thereof.

The anionic group of G can be selected from the group consisting of OSO₃M, SO₃M, CO₂M, OCO₂M, OPO₃M₂, OPO₃HM and OPO₂M. Suitably, the anionic group of G can be selected from the group consisting of OSO₃M, SO₃M, CO₂M, and OCO₂M. Suitably, the anionic group of G can be selected from the group consisting of SO₃M and CO₂M.

Naturally, different water soluble film and/or sheets of different thickness may be employed in making the compartments of the present invention. A benefit in selecting different films is that the resulting compartments may exhibit different solubility or release characteristics.

The water soluble film 20 herein can also comprise one or more additive ingredients. For example, it can be beneficial to add plasticizers, for example glycerol, ethylene glycol, diethyleneglycol, propylene glycol, sorbitol and mixtures thereof. Other additives may include water and functional detergent additives, including surfactant, to be delivered to the wash water, for example organic polymeric dispersants, etc.

### Ink

The ink 50 can be printed upon one the water soluble film 20. The ink 50 can be printed using any of the known techniques for printing on water soluble films. One technology that can be used is flexographic printing. A water soluble over print varnish, having little or no pigment, can be printed over the ink 50 to improve stability of the printing. The overprint varnish can be OPV AQUADESTRUCT, sold by Sun Chemical, Parsippany, N.J., United States of America. The water soluble film 20 can be a laminate and the ink 50 can be printed thereon.

The ink 50 can comprise between about 5% and about 30% by weight a solvent selected from the group consisting of diols, cyclic polyols, diglycols, triols, polyols, and mixtures thereof. Without being bound by theory, it is thought that an ink 50 comprised as such provides for the desired slow drying ink 50 that is absorbed rapidly into the water soluble film 20.

Historically, water based ink 50 has been employed for printing water soluble film 20 since water can be absorbed into water soluble film 20. But a slow line speeds, water based ink 50 may be susceptible to drying on components of the printing apparatus 10.

Solvents selected from the group consisting of diols, cyclic polyols, diglycols, triols, polyols, and mixtures thereof tend to have a slower evaporation rate than water under comparable environmental conditions. So, by providing an ink 50 with an appreciable mass fraction of the aforesaid solvents can slow down drying of the ink 50. Further, solvents selected from the group consisting of diols, cyclic polyols, diglycols, triols, polyols, and mixtures thereof tend to be rapidly absorbed into water soluble film 20. Hence, such solvents provide for an ink 50 having the desired slow drying property and the rapid absorption.

The ink 50 can comprise between about 35% and about 85% by weight water. Inks 50 having such a weight fraction of water are thought to be relatively easy to formulate and handle and produce acceptable printing quality for water soluble films 20.

The solvent can be selected from the group consisting of ethylene glycol, propylene glycol, butadiene glycol, cyclohexanedimethanol, cyclohexyl dimethanol, diethylene glycol, dipropylene glycol, glycerol, polyethylene glycol, polypropylene glycol, polybutadiene glycol, and mixtures thereof. The ink 50 can comprise between about 10% and about 25% by weight propylene glycol.

The formulation of the ink 50 can be considered as follows. Starting from a conventional ink 50 used for printing water soluble film 20, which might contain about 70% by weight water, about 14% by weight pigment, and the balance minors added to improve processing, some of the water is replaced with between about 5% and about 30% by weight of the ink 50 of solvent selected from the group consisting of diols, cyclic polyols, diglycols, triols, polyols, and mixtures thereof. The addition of such solvent tends to make the ink 50 evaporate more slowly than an ink 50 that contains a lesser amount of such solvent.

The ink 50 can comprise from about 1% by weight to about 50% by weight a pigment. The ink 60 can comprise from about 3% by weight to about 40% by weight a pigment. The ink 60 can comprise from about 5% by weight to about 35% by weight a pigment. The ink 60 can comprise from about 7% by weight to about 25% by weight a pigment. The ink 60 can comprise from about 9% by weight to about 20% by weight a pigment.

The ink 50 can partially absorb into water soluble film 20 upon which it is printed and partially dry on the surface. The absorption and drying can take between about 0.1 and about 5 seconds, or even from about 1 to about 3 seconds. The amount of ink 50 printed onto the water-soluble film 20 can affect the absorption and drying rate. The ink 60 can be applied at a weight from about 0.1 to about 30 g/m² of water soluble film 20, or even from about 0.5 to about 18 g/m² of water soluble film 20, or even from about 1 to about 10 g/m² of water soluble film 20 to obtain good printing quality. From about 1% to about 100%, or even about 10% to about 40%, of the water soluble film 20 can be printed upon. When printed upon the water soluble film 20, the ink 50 can partially dissolve the sheet and be absorbed into the sheet.

The ink 50 can be an ink 50 as set forth in the following table.

TABLE 1
Ink formulations.

| | [1] | [2] | [3] | [4] | [5] | [6] |
|---|---|---|---|---|---|---|
| | % by | % by | % by | % by | % by | % by |
| Ink Component | weight | weight | weight | weight | weight | weight |
| water | 65.075 | 61.65 | 58.225 | 54.8 | 51.375 | 47.95 |
| pyrrolo[3,4-c]pyrrole-1,4-dione, | 13.395 | 12.69 | 11.985 | 11.28 | 10.575 | 9.87 |
| 3,6-bis(4-chlorophenyl)-2,5- | | | | | | |
| dihydro- | | | | | | |
| acetic acid ethenyl ester, polymer | 9.785 | 9.27 | 8.755 | 8.24 | 7.725 | 7.21 |
| with ethenol | | | | | | |
| methanol | 0.095 | 0.09 | 0.085 | 0.08 | 0.075 | 0.07 |
| propanol, oxybis- | 0.095 | 0.09 | 0.085 | 0.08 | 0.075 | 0.07 |
| ammonia salt of modified styrene | 4.56 | 4.32 | 4.08 | 3.84 | 3.6 | 3.36 |
| acrylic polymer | | | | | | |
| 1-propanol | 1.9 | 1.8 | 1.7 | 1.6 | 1.5 | 1.4 |
| ethanol, 2-(2-ethoxyethoxy)- | 0.095 | 0.09 | 0.085 | 0.08 | 0.075 | 0.07 |
| solvent selected from the group | 5.000 | 10.000 | 15.000 | 20.000 | 25.000 | 30.000 |
| consisting of diols, cyclic | | | | | | |
| polyols, diglycols, triols, polyols, | | | | | | |
| and mixtures thereof | | | | | | |

The ink 60 can comprise AQUADESTRUCT black. The ink 60 can comprise AQUADESTRUCT white. AQUADESTRUCT inks are available from Sun Chemical, Parsippany, N.J., United States of America, that are diluted by adding between about 5% and about 30% by weight a solvent selected from the group consisting of diols, cyclic polyols, diglycols, triols, polyols, and mixtures thereof. The ink 60 can comprise one or more of DPW 354 White, DPW 354 Black, and DPW 354 Red, available from Sun Chemical, Parsippany, N.J., United States of America, that are diluted by adding between about 5% and about 30% by weight a solvent selected from the group consisting of diols, cyclic polyols, diglycols, triols, polyols, and mixtures thereof.

### Thermoforming

A pouch can be formed by thermoforming. In thermoforming, heat can be applied to the water soluble film 20. The heat may be applied using any suitable means. For example, the water soluble film 20 may be heated directly by passing it under a heating element or through hot air, prior to feeding it onto a surface or once on a surface. Alternatively, it may be heated indirectly, for example by heating the surface or applying a hot item onto the water soluble film. In some embodiments, the water soluble film is heated using an infrared lamp. The sheet may be heated to a temperature of about 50 to about 150 deg. C., about 50 to about 120 deg. C., about 60 to about 130 deg. C., about 70 to about 120 deg. C., or about 60 to about 90 deg. C. Alternatively, the sheet can be wetted by any suitable means, for example directly by spraying a wetting agent (including water, a solution of the film composition, a plasticizer for the film composition, or any combination of the foregoing) onto the water soluble film 20, prior to feeding it onto the forming surface 140 or once on the forming surface 140, or indirectly by wetting the forming surface 140 or by applying a wet item onto the water soluble film 20.

Once the water soluble film 20 has been heated and/or wetted, it may be drawn into an appropriate mold, for example by using a vacuum. The filling of the molded water soluble film 20 can be accomplished using any suitable means. In some embodiments, the method will depend on the product form and required speed of filling. In some embodiments, the molded water soluble film 20 is filled by in-line filling techniques. The filled, open containers are then closed forming the pouches, using another water soluble film 20, by any suitable method. This may be accomplished while in horizontal position and in continuous, constant motion. The closing may be accomplished by continuously feeding a water soluble film 20 over and onto the open containers and then sealing the water soluble films 20 together, typically in the area between the molds and thus between the containers.

Any suitable method of sealing the container and/or the individual compartments thereof may be utilized. Non-limiting examples of such means include heat sealing, solvent welding, solvent or wet sealing, and combinations thereof. Heat and or solvent can be applied to the entire surface of the water soluble film 20 or only the area which is to form the seal is treated with heat or solvent. The heat or solvent can be applied by any method, typically on the closing material, and typically only on the areas which are to form the seal. If solvent or wet sealing or welding is used, heat can also be applied. Wet or solvent sealing/welding methods include selectively applying solvent onto the area between the molds, or on the closing material, by for example, spraying or printing this onto these areas, and then applying pressure onto these areas, to form the seal. Sealing rolls and belts as described above that optionally also provide heat can be used, for example.

The formed pouches may then be cut by a cutting device. Cutting can be accomplished using any known method. The cutting can be done in continuous manner, optionally with constant speed and in a horizontal position. The cutting device can, for example, be a sharp item or a hot item, whereby in the latter case, the hot item ‘burns’ through the sheet/sealing area.

The different compartments of a multi-compartment pouches may be made together in a side-by-side style wherein the resulting, cojoined pouches may or may not be separated by cutting. Alternatively, the compartments can be made separately and then joined together for example in a superposed position.

### EXAMPLES/COMBINATIONS

A. A process comprising the steps of:
   providing a water soluble film;
   providing an ink comprising between about 5% and about 30% by weight a solvent selected from the group consisting of diols, cyclic polyols, diglycols, triols, polyols, and mixtures thereof;
   applying said ink onto said water soluble film; and
   incorporating a surface treatment composition onto, into, at least partially enclosed by, or enclosed by said water soluble film;
   wherein said surface treatment composition is selected from the group consisting of a fabric conditioner, a laundry conditioner, a fabric detergent, a laundry detergent, a laundry rinse additive, a hard surface cleaner, a hard surface treatment composition, an air care composition, a car care composition, a dishwashing composition, a composting composition, a cleaning product, and combinations thereof.
B. The process according to paragraph A, wherein said ink is applied onto said water soluble film by an ink application process selected from the group consisting of flexographic printing, gravure printing, lithographic printing, and pad printing.
C. The process according to paragraph A or B, wherein said ink comprises between about 35% and about 85% by weight water.
D. The process according to paragraph C wherein said ink is retained on a flexographic print cylinder for between about 0.5 seconds and about 8 seconds before being printed on said water soluble film.
E. The process according to any one of paragraphs A through D, wherein said water soluble film is provided as a continuous web moving at a speed between about 2 m/min and about 50 m/min.
F. The process according to any one of paragraphs A through E, wherein said solvent is selected from the group consisting of ethylene glycol, propylene glycol, butadiene glycol, cyclohexanedimethanol, cyclohexyl dimethanol, diethylene glycol, dipropylene glycol, glycerol, polyethylene glycol, polypropylene glycol, polybutadiene glycol, and mixtures thereof.
G. The process according to any one of paragraphs A through F, wherein said solvent is propylene glycol.
H. The process according to any one of paragraphs A through G, wherein said ink comprises between about 10% and about 25% by weight propylene glycol.
I. The process according to any one of paragraphs A through H, wherein said water soluble film comprises polyvinyl alcohol.
J. The process according to any one of paragraphs A through I, further comprising the step of forming a pouch comprising said water soluble film.
K. The process according to any one of paragraphs A through J, wherein said ink is positioned on an inside surface of said pouch.
L. The process according to paragraph C, wherein said ink is retained on a gravure print cylinder for between about 0.5 seconds and about 8 seconds before being printed on said water soluble film.
M. The process according to paragraph L, wherein said water soluble film is provided as a continuous web moving at a speed between about 2 m/min and about 50 m/min.
N. The process according to paragraph L or M, wherein said solvent is selected from the group consisting of ethylene glycol, propylene glycol, butadiene glycol, cyclohexanedimethanol, cyclohexyl dimethanol, diethylene glycol, dipropylene glycol, glycerol, polyethylene glycol, polypropylene glycol, polybutadiene glycol, and mixtures thereof.
O. The process according to any one of paragraphs L through N, wherein said solvent is propylene glycol.
P. The process according to any one of paragraphs L through O, wherein said ink comprises between about 10% and about 25% by weight propylene glycol.
Q. The process according to any one of paragraphs L through P, wherein said water soluble film comprises polyvinyl alcohol.
R. The process according to any one of paragraphs L through Q, further comprising the step of forming a pouch comprising said water soluble film.
S. The process according to any one of paragraphs L through R, wherein said ink is positioned on an inside surface of said pouch.
T. A process comprising the steps of:
   providing a water soluble film comprising polyvinyl alcohol;
   providing an ink comprising between about 10% and about 25% by weight propylene glycol;
   applying said ink onto said water soluble film; and
   incorporating a surface treatment composition onto, into, at least partially enclosed by, or enclosed by said water soluble film;
   wherein said surface treatment composition is selected from the group consisting of a fabric conditioner, a laundry conditioner, a fabric detergent, a laundry detergent, a laundry rinse additive, a hard surface cleaner, a hard surface treatment composition, an air care composition, a car care composition, a dishwashing composition, a composting composition, a cleaning product, and combinations thereof;
   wherein said ink is applied onto said water soluble film by an ink application process selected from the group consisting of flexographic printing, gravure printing, lithographic printing, and pad printing; and
   wherein said water soluble film is provided as a continuous web moving at a speed between about 2 m/min and about 50 m/min.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A process comprising the steps of:
providing a water soluble film;
providing an ink comprising between about 5% and about 30% by weight a solvent selected from the group consisting of diols, cyclic polyols, diglycols, triols, polyols, and mixtures thereof;
applying said ink onto said water soluble film; and
incorporating a surface treatment composition enclosed by said water soluble film in a pouch formed by said water soluble film;
wherein said surface treatment composition is selected from the group consisting of a fabric conditioner, a laundry conditioner, a fabric detergent, a laundry detergent, a laundry rinse additive, a hard surface cleaner, a hard surface treatment composition, an air care composition, a car care composition, a dishwashing composition, a composting composition, a cleaning product, and combinations thereof;
wherein said ink is positioned on an inside surface of said pouch.

2. The process according to claim 1, wherein said ink is applied onto said water soluble film by an ink application process selected from the group consisting of flexographic printing, gravure printing, lithographic printing, and pad printing.

3. The process according to claim 2, wherein said ink comprises between about 35% and about 85% by weight water.

4. The process according to claim 3 wherein said ink is retained on a flexographic print cylinder for between about 0.5 seconds and about 8 seconds before being printed on said water soluble film.

5. The process according to claim 4, wherein said water soluble film is provided as a continuous web moving at a speed between about 2 m/min and about 50 m/min.

6. The process according to claim 5, wherein said solvent is selected from the group consisting of ethylene glycol, propylene glycol, butadiene glycol, cyclohexanedimethanol, cyclohexyl dimethanol, diethylene glycol, dipropylene glycol, glycerol, polyethylene glycol, polypropylene glycol, polybutadiene glycol, and mixtures thereof.

7. The process according to claim 6, wherein said solvent is propylene glycol.

8. The process according to claim 7, wherein said ink comprises between about 10% and about 25% by weight propylene glycol.

9. The process according to claim 8, wherein said water soluble film comprises polyvinyl alcohol.

10. (canceled)

11. (canceled)

12. The process according to claim 3 wherein said ink is retained on a gravure print cylinder for between about 0.5 seconds and about 8 seconds before being printed on said water soluble film.

13. The process according to claim 12, wherein said water soluble film is provided as a continuous web moving at a speed between about 2 m/min and about 50 m/min.

14. The process according to claim 13, wherein said solvent is selected from the group consisting of ethylene glycol, propylene glycol, butadiene glycol, cyclohexanedimethanol, cyclohexyl dimethanol, diethylene glycol, dipropylene glycol, glycerol, polyethylene glycol, polypropylene glycol, polybutadiene glycol, and mixtures thereof.

15. The process according to claim 14, wherein said solvent is propylene glycol.

16. The process according to claim 15, wherein said ink comprises between about 10% and about 25% by weight propylene glycol.

17. The process according to claim 16, wherein said water soluble film comprises polyvinyl alcohol.

18. (canceled)

19. (canceled)

20. A process comprising the steps of:
providing a water soluble film comprising polyvinyl alcohol;
providing an ink comprising between about 10% and about 25% by weight propylene glycol;
applying said ink onto said water soluble film; and
incorporating a surface treatment composition onto, into, at least partially enclosed by, or enclosed by said water soluble film;
wherein said surface treatment composition is selected from the group consisting of a fabric conditioner, a laundry conditioner, a fabric detergent, a laundry detergent, a laundry rinse additive, a hard surface cleaner, a hard surface treatment composition, an air care composition, a car care composition, a dishwashing composition, a composting composition,
a cleaning product, and combinations thereof;
wherein said ink is applied onto said water soluble film by an ink application process selected from the group consisting of flexographic printing, gravure printing, lithographic printing, and pad printing; and
wherein said water soluble film is provided as a continuous web moving at a speed between about 2 m/min and about 50 m/min.
